(19) United States
(12) Patent Application Publication
(10) Pub. No.: US 2020/0086531 A1
(43) Pub. Date: Mar. 19, 2020

(54) ANTI-SLIP SALAD BOWL AND METHOD FOR MANUFACTURING THE SAME

(71) Applicant: Foshan Shi Shunde Jetwell Stainless Steel Products Limited, Foshan (CN)

(72) Inventor: Ngai Kin Lam, Foshan (CN)

(21) Appl. No.: 16/182,617

(22) Filed: Nov. 7, 2018

(30) Foreign Application Priority Data
Sep. 17, 2018 (CN) 201811081987.9

(51) Int. Cl. B29C 37/00; B29C 35/02; B65D 25/34; A47G 19/02

(52) U.S. Cl. CPC B29C 37/0025; B29C 35/02; B29K 2083/00; A47G 19/02; B65D 25/34

(57) ABSTRACT

The present disclosure provides an anti-slip salad bowl which includes an enamel body. An outer bottom of the enamel body is coated with a silicone adhesive layer and a mixed silicone rubber layer. Correspondingly, the disclosure further provides a method for manufacturing the anti-slip salad bowl. On one hand, since the manufacturing is convenient and the related materials are easily available, the resultant bowl is cost effective. On the other hand, since the outer bottom of the enamel body is bonded with an anti-slip layer made of silicone rubber, silicone rubber adhesive, vulcanizing agent and color concentrate, the bowl will not be prone to slipping when moved or used to mix salad.

### CROSS-REFERENCE TO RELATED APPLICATION

The present application claims benefit of Chinese Patent Application 201811081987.9, filed on Sep. 17, 2018, the contents of which are hereby incorporated by reference in its entirety.

### TECHNICAL FIELD

The present disclosure relates to the technical filed of manufacturing bowls, and particularly relates to an anti-slip salad bowl and method for manufacturing the salad bowl.

### BACKGROUND

Salad bowls on the market may be made of stainless steel, ceramics, glasses, enamels etc. Since it is hard to bond an anti-slip base to salad bowls made of ceramics and glasses, the salad bowls made of ceramics and glasses are prone to slipping. Merely the salad bowls made of stainless steel have anti-slip bases bonded thereto. However, the stainless steel is relatively expensive and cannot form multicolor contrast with the enamel. Therefore, merchants and consumers have been looking forward to an enamel bowel with an anti-slip base.

### SUMMARY

According to an aspect, an anti-slip salad bowl is provided. The anti-slip salad bowl includes an enamel body. An outer bottom of the enamel body is coated with a silicone adhesive layer and a mixed silicone rubber layer.

According to another aspect, a method for manufacturing an anti-slip salad bowl with an enamel body is provided. The method includes the following actions.

In Action 1, an outer bottom of the enamel body is immerged into silicone adhesive held in a container. The outer bottom is then dried to obtain an enamel bowl bonded with the silicone adhesive.

In Action 2, silicone rubber, vulcanizing agent and color concentrate are mixed to obtain mixed silicone rubber, and the mixed silicone rubber is pressed to obtain flaky mixed silicone rubber.

In Action 3, the flaky mixed silicone rubber is coated onto an outer bottom of the enamel bowl boned with the silicone adhesive obtained according to the Action 1, to obtain an enamel bowl provided with a bottom coated with the mixed silicone rubber.

In Action 4, within a mould, high temperature vulcanization is performed on the enamel bowl provided with the bottom coated with the mixed silicone rubber which is obtained in the Action 3. The enamel bowl is cleaned to obtain the anti-slip salad bowl.

### DETAILED DESCRIPTION

In order to make the purposes, technical solutions and advantages of the present disclosure clearer, the disclosure will be further described below in combination with the drawings and the embodiments in detail. It should be understood that the specific embodiments described herein are only adopted to explain the application and not intended to limit the disclosure.

An embodiment of the disclosure provides a method for manufacturing an anti-slip salad bowl. The method includes the following actions.

Action 1, an outer bottom of an enamel body is immerged into silicone adhesive held in a container. Then the outer bottom is dried under a temperature of 60˜80° C. for 10˜30 minutes to obtain an enamel bowl bonded with the silicone adhesive. The silicon adhesive may be at least one of One Component Room Temperature Vulcanized Silicone rubber Adhesive, One Component Heating cured Silicone rubber Adhesive or Two Component Heating cured Silicone rubber Adhesive.

Action 2, 15˜25 kg of silicone rubber, 0.1˜0.5 kg of vulcanizing agent and 0.1˜0.5 kg of color concentrate are mixed under a temperature of 80˜90° C. for 20˜30 minutes, so as to obtain mixed silicone rubber. Then the mixed silicone rubber is pressed to obtain flaky mixed silicone rubber with a thickness of 2˜5 mm. The silicone rubber may be at least one of One Component Room Temperature Vulcanized Silicone rubber, One Component Heating cured Silicone rubber or Two Component Heating cured Silicone rubber. The vulcanizing agent may be in a form of transparent paste.

Action 3, 40˜50 g of the flaky mixed silicone rubber is coated onto an outer bottom of the enamel bowl boned with the silicone adhesive that is obtained according to the Action 1 (the position in which the mixed silicone rubber is coated, is the position at which the silicone adhesive is bonded to the enamel bowl in Action 1), so as to obtain an enamel bowl provided with a bottom coated with the mixed silicone rubber.

Action 4, high temperature vulcanization is performed under a temperature of 180˜220° C. for 30˜60 minutes, within a mould, on the enamel bowl provided with the bottom coated with the mixed silicone rubber that is obtained in the Action 3. Then the enamel bowl is cleaned to obtain the anti-slip salad bowl.

On one hand, since above process is convenient and the related materials are easily available, the resultant bowl is cost effective. On the other hand, since the outer bottom of the enamel body is bonded with an anti-slip layer made of silicone rubber, silicone rubber adhesive, vulcanizing agent and color concentrate, the bowl will not be prone to slipping when moved or used to mix salad.

### First Embodiment

Action 1, an outer bottom of an enamel body is immerged into One Component Room Temperature Vulcanized Silicone rubber Adhesive held in a container. Then the outer bottom is dried under a temperature of 70° C. for 20 minutes to obtain an enamel bowl bonded with the silicone adhesive.

Action 2, 20 kg of One Component Room Temperature Vulcanized Silicone rubber, 0.2 kg of vulcanizing agent and 0.2 kg of color concentrate are mixed under a temperature of 85° C. for 25 minutes, so as to obtain mixed silicone rubber. Then the mixed silicone rubber is pressed to obtain flaky mixed silicone rubber with a thickness of 3 mm.

Action 3, 45 g of the flaky mixed silicone rubber is coated onto an outer bottom of the enamel bowl boned with the silicone adhesive that is obtained according to the Action 1, so as to obtain an enamel bowl provided with a bottom coated with the mixed silicone rubber.

Action 4, high temperature vulcanization is performed under a temperature of 200° C. for 40 minutes, within a mould, on the enamel bowl provided with the bottom coated with the mixed silicone rubber that is obtained in the Action 3. Then the enamel bowl is cleaned to obtain the anti-slip salad bowl.

### Second Embodiment

Action 1, an outer bottom of an enamel body is immerged into One component Heating cured Silicone rubber adhesive held in a container. Then the outer bottom is dried under a temperature of 60° C. for 30 minutes to obtain an enamel bowl bonded with the silicone adhesive.

Action 2, 15 kg of One Component Heating cured Silicone rubber, 0.1 kg of vulcanizing agent and 0.1 kg of color concentrate are mixed under a temperature of 80° C. for 30 minutes, so as to obtain mixed silicone rubber. Then the mixed silicone rubber is pressed to obtain flaky mixed silicone rubber with a thickness of 2 mm.

Action 3, 40 g of the flaky mixed silicone rubber is coated onto an outer bottom of the enamel bowl boned with the silicone adhesive that is obtained according to the Action 1, so as to obtain an enamel bowl provided with a bottom coated with the mixed silicone rubber.

Action 4, high temperature vulcanization is performed under a temperature of 180° C. for 60 minutes, within a mould, on the enamel bowl provided with the bottom coated with the mixed silicone rubber that is obtained in the Action 3. Then the enamel bowl is cleaned to obtain the anti-slip salad bowl.

### Third Embodiment

Action 1, an outer bottom of an enamel body is immerged into Two Component Heating cured Silicone rubber Adhesive held in a container. Then the outer bottom is dried under a temperature of 80° C. for 10 minutes to obtain an enamel bowl bonded with the silicone adhesive.

Action 2, 25 kg of Two Component Heating cured Silicone rubber, 0.5 kg of vulcanizing agent and 0.5 kg of color concentrate are mixed under a temperature of 90° C. for 20 minutes, so as to obtain mixed silicone rubber. Then the mixed silicone rubber is pressed to obtain flaky mixed silicone rubber with a thickness of 5 mm.

Action 3, 50 g of the flaky mixed silicone rubber is coated onto an outer bottom of the enamel bowl boned with the silicone adhesive that is obtained according to the Action 1, so as to obtain an enamel bowl provided with a bottom coated with the mixed silicone rubber.

Action 4, high temperature vulcanization is performed under a temperature of 220° C. for 30 minutes, within a mould, on the enamel bowl provided with the bottom coated with the mixed silicone rubber that is obtained in the Action 3. Then the enamel bowl is cleaned to obtain the anti-slip salad bowl.

### Fourth Embodiment

Action 1, an outer bottom of an enamel body is immerged into One Component Room Temperature Vulcanized Silicone rubber Adhesive held in a container. Then the outer bottom is dried under a temperature of 70° C. for 20 minutes to obtain an enamel bowl bonded with the silicone adhesive.

Action 2, 20 kg of One Component Room Temperature Vulcanized Silicone rubber, 0.2 kg of vulcanizing agent and 0.2 kg of color concentrate are mixed under a temperature of 85° C. for 25 minutes, so as to obtain mixed silicone rubber. Then the mixed silicone rubber is pressed to obtain flaky mixed silicone rubber with a thickness of 3 mm.

Action 3, 45 g of the flaky mixed silicone rubber is coated onto an outer bottom of the enamel bowl boned with the silicone adhesive that is obtained according to the Action 1, so as to obtain an enamel bowl provided with a bottom coated with the mixed silicone rubber.

Action 4, high temperature vulcanization is performed under a temperature of 180° C. for 60 minutes, within a mould, on the enamel bowl provided with the bottom coated with the mixed silicone rubber that is obtained in the Action 3. Then the enamel bowl is cleaned to obtain the anti-slip salad bowl.

### Fifth Embodiment

Action 1, an outer bottom of an enamel body is immerged into One Component Room Temperature Vulcanized Silicone rubber Adhesive held in a container. Then the outer bottom is dried under a temperature of 70° C. for 20 minutes to obtain an enamel bowl bonded with the silicone adhesive.

Action 2, 20 kg of One Component Room Temperature Vulcanized Silicone rubber, 0.2 kg of vulcanizing agent and 0.2 kg of color concentrate are mixed under a temperature of 85° C. for 25 minutes, so as to obtain mixed silicone rubber. Then the mixed silicone rubber is pressed to obtain flaky mixed silicone rubber with a thickness of 3 mm.

Action 3, 45 g of the flaky mixed silicone rubber is coated onto an outer bottom of the enamel bowl boned with the silicone adhesive that is obtained according to the Action 1, so as to obtain an enamel bowl provided with a bottom coated with the mixed silicone rubber.

Action 4, high temperature vulcanization is performed under a temperature of 220° C. for 30 minutes, within a mould, on the enamel bowl provided with the bottom coated with the mixed silicone rubber that is obtained in the Action 3. Then the enamel bowl is cleaned to obtain the anti-slip salad bowl.

### Sixth Embodiment

Action 1, an outer bottom of an enamel body is immerged into One Component Heating cured Silicone rubber Adhesive held in a container. Then the outer bottom is dried under a temperature of 60° C. for 30 minutes to obtain an enamel bowl bonded with the silicone adhesive.

Action 2, 15 kg of One Component Heating cured Silicone rubber, 0.1 kg of vulcanizing agent and 0.1 kg of color concentrate are mixed under a temperature of 80° C. for 30 minutes, so as to obtain mixed silicone rubber. Then the mixed silicone rubber is pressed to obtain flaky mixed silicone rubber with a thickness of 2 mm.

Action 3, 40 g of the flaky mixed silicone rubber is coated onto an outer bottom of the enamel bowl boned with the silicone adhesive that is obtained according to the Action 1, so as to obtain an enamel bowl provided with a bottom coated with the mixed silicone rubber.

Action 4, high temperature vulcanization is performed under a temperature of 220° C. for 40 minutes, within a mould, on the enamel bowl provided with the bottom coated with the mixed silicone rubber that is obtained in the Action 3. Then the enamel bowl is cleaned to obtain the anti-slip salad bowl.

### Seventh Embodiment

Action 1, an outer bottom of an enamel body is immerged into One Component Heating cured Silicone rubber Adhesive held in a container. Then the outer bottom is dried under a temperature of 60° C. for 30 minutes to obtain an enamel bowl bonded with the silicone adhesive.

Action 2, 15 kg of One Component Heating cured Silicone rubber, 0.1 kg of vulcanizing agent and 0.1 kg of color concentrate are mixed under a temperature of 80° C. for 30 minutes, so as to obtain mixed silicone rubber. Then the mixed silicone rubber is pressed to obtain flaky mixed silicone rubber with a thickness of 2 mm.

Action 3, 40 g of the flaky mixed silicone rubber is coated onto an outer bottom of the enamel bowl boned with the silicone adhesive that is obtained according to the Action 1, so as to obtain an enamel bowl provided with a bottom coated with the mixed silicone rubber.

Action 4, high temperature vulcanization is performed under a temperature of 220° C. for 30 minutes, within a mould, on the enamel bowl provided with the bottom coated with the mixed silicone rubber that is obtained in the Action 3. Then the enamel bowl is cleaned to obtain the anti-slip salad bowl.

### Eighth Embodiment

Action 1, an outer bottom of an enamel body is immerged into Two Component Heating cured Silicone rubber Adhesive held in a container. Then the outer bottom is dried under a temperature of 80° C. for 10 minutes to obtain an enamel bowl bonded with the silicone adhesive.

Action 2, 25 kg of Two Component Heating cured Silicone rubber, 0.5 kg of vulcanizing agent and 0.5 kg of color concentrate are mixed under a temperature of 90° C. for 20 minutes, so as to obtain mixed silicone rubber. Then the mixed silicone rubber is pressed to obtain flaky mixed silicone rubber with a thickness of 5 mm.

Action 3, 50 g of the flaky mixed silicone rubber is coated onto an outer bottom of the enamel bowl boned with the silicone adhesive that is obtained according to the Action 1, so as to obtain an enamel bowl provided with a bottom coated with the mixed silicone rubber.

Action 4, high temperature vulcanization is performed under a temperature of 200° C. for 40 minutes, within a mould, on the enamel bowl provided with the bottom coated with the mixed silicone rubber that is obtained in the Action 3. Then the enamel bowl is cleaned to obtain the anti-slip salad bowl.

### Ninth Embodiment

Action 1, an outer bottom of an enamel body is immerged into Two Component Heating cured Silicone rubber Adhesive held in a container. Then the outer bottom is dried under a temperature of 80° C. for 10 minutes to obtain an enamel bowl bonded with the silicone adhesive.

Action 2, 25 kg of Two Component Heating cured Silicone rubber, 0.5 kg of vulcanizing agent and 0.5 kg of color concentrate are mixed under a temperature of 90° C. for 20 minutes, so as to obtain mixed silicone rubber. Then the mixed silicone rubber is pressed to obtain flaky mixed silicone rubber with a thickness of 5 mm.

Action 3, 50 g of the flaky mixed silicone rubber is coated onto an outer bottom of the enamel bowl boned with the silicone adhesive that is obtained according to the Action 1, so as to obtain an enamel bowl provided with a bottom coated with the mixed silicone rubber.

Action 4, high temperature vulcanization is performed under a temperature of 180° C. for 60 minutes, within a mould, on the enamel bowl provided with the bottom coated with the mixed silicone rubber that is obtained in the Action 3. Then the enamel bowl is cleaned to obtain the anti-slip salad bowl.

### EXPERIMENTS

Tests regarding a pulling force (bonding force), acid resistance and alkali resistance are performed on the bases of the salad bowls obtained according to the embodiments 1 to 9. The test results are listed in Table 1 below.

TABLE 1

| | Pulling | | |
|---|---|---|---|
| | force | | |
| | (bonding | | |
| | force) | Acid resistance | Alkali resistance |
| First embodiment | 39.2 N | Base unchanged | Base unchanged |
| Second embodiment | 24.5 N | Base unchanged | Base unchanged |
| Third embodiment | 29.4 N | Base unchanged | Base unchanged |
| Fourth embodiment | 19.6 N | Base unchanged | Base unchanged |
| Fifth embodiment | 44.1 N | Base unchanged | Base unchanged |
| Sixth embodiment | 39.2 N | Base unchanged | Base unchanged |
| Seventh Embodiment | 39.2 N | Base unchanged | Base unchanged |
| Eighth Embodiment | 34.3 N | Base unchanged | Base unchanged |
| Nine embodiment | 29.4 N | Base unchanged | Base unchanged |
| Comparative | 14.7 N | Base changed | Base changed |
| embodiment | | | |

As shown in the Table 1, the anti-slip layer at the bottom of the anti-slip salad bowl according to the present disclosure, is superior over that of the conventional salad bowl in terms of the bonding force, the acid resistance and alkali resistance, and is worth to be popularized.

The abovementioned embodiments only express some implementation modes of the disclosure and are specifically described in detail and not thus understood as limits to the patent scope of the disclosure.

1. An anti-slip salad bowl, comprising an enamel body, wherein an outer bottom of the enamel body is coated with a silicone adhesive layer and a mixed silicone rubber layer.

2. A method for manufacturing an anti-slip salad bowl with an enamel body, the method comprising:
Action 1, immerging an outer bottom of the enamel body into silicone adhesive held in a container, and drying the outer bottom to obtain an enamel bowl bonded with the silicone adhesive;
Action 2, mixing silicone rubber, vulcanizing agent and color concentrate to obtain mixed silicone rubber, and pressing the mixed silicone rubber to obtain flaky mixed silicone rubber;
Action 3, coating the flaky mixed silicone rubber onto an outer bottom of the enamel bowl boned with the silicone adhesive obtained according to the Action 1, to obtain an enamel bowl provided with a bottom coated with the mixed silicone rubber; and
Action 4, performing, within a mould, high temperature vulcanization on the enamel bowl provided with the bottom coated with the mixed silicone rubber which is obtained in the Action 3, and cleaning the enamel bowl to obtain the anti-slip salad bowl.

3. The method for manufacturing an anti-slip salad bowl according to claim 2, wherein in the Action 1, the silicon adhesive is at least one of One Component Room Temperature Vulcanized Silicone rubber Adhesive, One Component Heating cured Silicone rubber Adhesive or Two Component Heating cured Silicone rubber Adhesive.

4. The method for manufacturing an anti-slip salad bowl according to claim 3, wherein the Action 2 further comprises:
mixing 15˜25 kg of silicone rubber, 0.1˜0.5 kg of vulcanizing agent and 0.1˜0.5 kg of color concentrate within a mixer to obtain mixed silicone rubber; and pressing the mixed silicone rubber to obtain flaky mixed silicone rubber.

5. The method for manufacturing an anti-slip salad bowl according to claim 4, wherein the silicone rubber is at least one of One Component Room Temperature Vulcanized Silicone rubber, One Component Heating cured Silicone rubber or Two Component Heating cured Silicone rubber.

6. The method for manufacturing an anti-slip salad bowl according to claim 5, wherein the mixing is performed under a temperature of 80˜90° C. for 20˜30 minutes.

7. The method for manufacturing an anti-slip salad bowl according to claim 6, wherein the flaky mixed silicone rubber has a thickness of 2˜5 mm.

8. The method for manufacturing an anti-slip salad bowl according to claim 7, wherein in the Action 2, the vulcanizing agent is in a form of transparent paste.

9. The method for manufacturing an anti-slip salad bowl according to claim 8, wherein in the Action 3, the coated flaky mixed silicone rubber has a weight of 40˜50 g.

10. The method for manufacturing an anti-slip salad bowl according to claim 2, wherein in the Action 4, the high temperature vulcanization is performed under a temperature of 180˜220° C. for 30˜60 minutes.

11. The method for manufacturing an anti-slip salad bowl according to claim 3, wherein in the Action 4, the high temperature vulcanization is performed under a temperature of 180˜220° C. for 30˜60 minutes.

12. The method for manufacturing an anti-slip salad bowl according to claim 4, wherein in the Action 4, the high temperature vulcanization is performed under a temperature of 180˜220° C. for 30˜60 minutes.
